(19) United States
(12) Patent Application Publication
(10) Pub. No.: US 2025/0283396 A1
(43) Pub. Date: Sep. 11, 2025

(54) RE-START OF WELL AFTER A WELL KILL OPERATION

(71) Applicant: Saudi Arabian Oil Company, Dhahran (SA)

(72) Inventors: Chidirim Enoch Ejim, Dhahran (SA); Omar A. Alyemni, Dhahran (SA); Eiman H. Munif, Saihat (SA)

(21) Appl. No.: 18/599,977

(22) Filed: Mar. 8, 2024

(51) Int. Cl. E21B 43/24; E21B 43/12

(52) U.S. Cl. CPC E21B 43/2401; E21B 33/072; E21B 36/04; E21B 43/121; H05B 3/56

(57) ABSTRACT

A heater cable is disposed through a wellhead assembly into a production tubing string and is lowered such that it is at least partially immersed within a volume of a well kill fluid. Prior to the immersion, a density of the well kill fluid relative to the produced fluids at the downhole end is such that the volume of well kill fluid prevents the flow of the produced fluids from the subterranean zone into the production tubing string. An electric current is flowed though the heater cable, and the heater cable converts the electric current to heat energy. The heat energy is transferred by conduction to the kill fluid thereby reducing the density of the well kill fluid relative to the produced fluids such that the well kill fluid rises in an uphole direction through the production tubing string.

### TECHNICAL FIELD

This disclosure relates to well operations, and in particular to operations to stop and re-start flow of produced fluids from the well.

### BACKGROUND

It is sometimes necessary or desirable to stop produced fluids from flowing from a wellbore. One kind of operation to stop such flow is to “kill” the well by disposing high-density fluid (a “kill fluid”), such as brine, into the wellbore. The kill fluid is of sufficient density to act as a barrier to the flow of produced (lower-density) fluid uphole through the wellbore. After a well has been killed, it is sometimes necessary or desirable to reverse the well kill; i.e., to bring the well back to production by removing the kill fluid from the well.

### SUMMARY

Certain aspects of the subject matter herein can be implemented as a method. The method includes disposing a heater cable through a wellhead assembly into a production tubing string, the production tubing string positioned within a wellbore drilled into a subterranean zone and configured to convey a flow of produced fluids from the subterranean zone to the wellhead assembly. The heater cable is lowered within the production tubing string in a downhole direction such that the heater cable is at least partially immersed within a volume of a well kill fluid disposed at a downhole end of the production tubing string. Prior to the immersion, a density of the well kill fluid relative to the produced fluids at the downhole end is such that the volume of well kill fluid prevents the flow of the produced fluids from the subterranean zone into the production tubing string. An electric current is flowed through the heater cable, and the heater cable converts the electric current to heat energy. The heat energy is transferred by conduction to the kill fluid thereby reducing the density of the well kill fluid relative to the produced fluids such that the well kill fluid rises in an uphole direction through the production tubing string.

Certain aspects of the subject matter herein can be implemented as a system that includes a production tubing string positioned within a well and configured to carry produced fluids from a subterranean zone to a terranean surface location and a wellhead assembly at the surface location configured to regulate a flow of fluid from the production tubing string. A volume of well kill fluid is disposed in the production tubing, with the well kill fluid having a density relative to the produced fluids at an ambient downhole temperature such that the volume of well kill fluid at the ambient downhole temperature prevents the flow of the produced fluids from the subterranean zone into the production tubing string. The system further includes a heater cable disposed through the wellhead assembly and into the volume of well kill fluid. The heater cable is configured such that, when an electric current is flowed through the heater cable, the electrical current is converted to heat energy and the heat energy is transferred by conduction to the kill fluid, thereby reducing the density of the well kill fluid relative to the produced fluids such that the well kill fluid rises in an uphole direction through the production tubing string, thereby permitting a flow of the produced fluids from the subterranean zone into the production tubing string.

The details of one or more embodiments are set forth in the accompanying drawings and the description below. Other features, objects, and advantages will be apparent from the description and drawings, and from the claims.

### DESCRIPTION OF DRAWINGS

FIG. 1 s a process flow diagram of a method of well operations in accordance with an embodiment of the present disclosure.

FIGS. 2A-2D are schematic diagrams of a well system in accordance with an embodiment of the present disclosure.

FIG. 3 is a schematic illustration of a heater cable in accordance with an embodiment of the present disclosure.

FIG. 4 is a schematic illustration of a heater cable disposed in a production tubing string in accordance with an embodiment of the present disclosure.

### DETAILED DESCRIPTION

Various methods and systems have been utilized for reversing a well kill; i.e., to bring the well back to production by removing the well kill fluid from the wellbore. For example, a downhole pump can be installed to pump the kill fluid back uphole. Alternatively, coiled tubing nitrogen injection can be utilized to lighten the fluid column above the reservoir. Such conventional kill-reverse methods can require a large surface footprint of equipment and personnel, high operating costs, and lost rig time. In addition, pressurized nitrogen can cause health, safety, and environmental concerns. In accordance with embodiments of the present disclosure, a method includes disposing a heater cable through a wellhead assembly into a production tubing string. The heater cable is lowered downhole within the production tubing such that it is at least partially immersed within a volume of a well kill fluid disposed at a downhole end of the production tubing string. An electric current is flowed through the heater cable, thereby generating heat energy from resistance of the heater cable to the electrical current. The heat energy generated by the heater cable reduces the density of the well kill fluid relative to the produced fluids such that the well kill fluid rises in an uphole direction through the production tubing string.

By reducing or eliminating the need for pumps, high-pressure gas, and other such equipment and specialty processes, the present disclosure can provide a simple and effective system and method which can more cost-effectively reverse a well kill, reducing surface operational footprint, costs, and rig time as compared to conventional kill reversal methods. The heating cable can be inserted and removed using standard intervention systems (such as standard lubricator equipment), integrating with existing oil or gas operations with minimal disruption, thus reducing environmental, health, and safety risks.

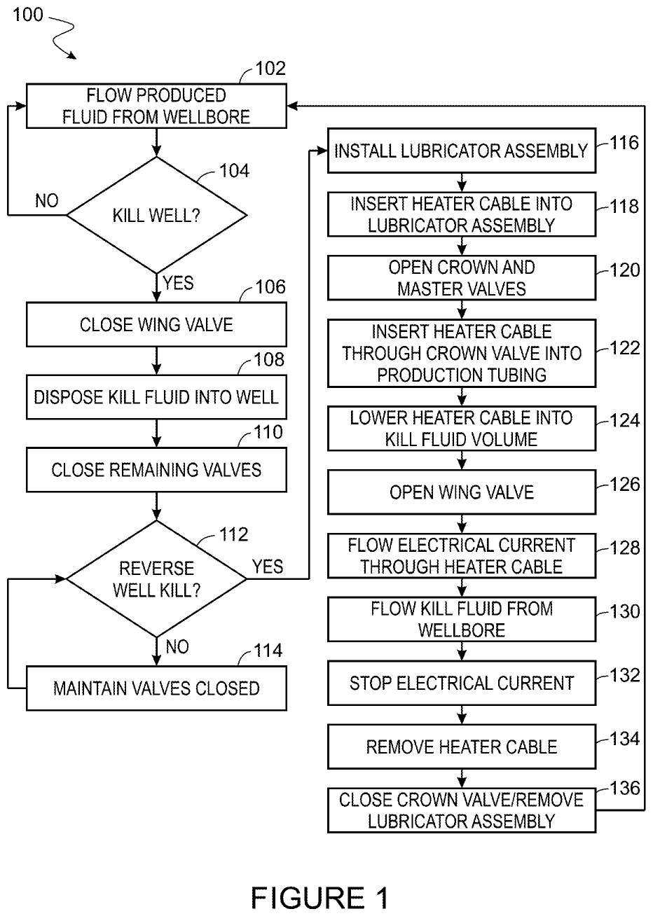

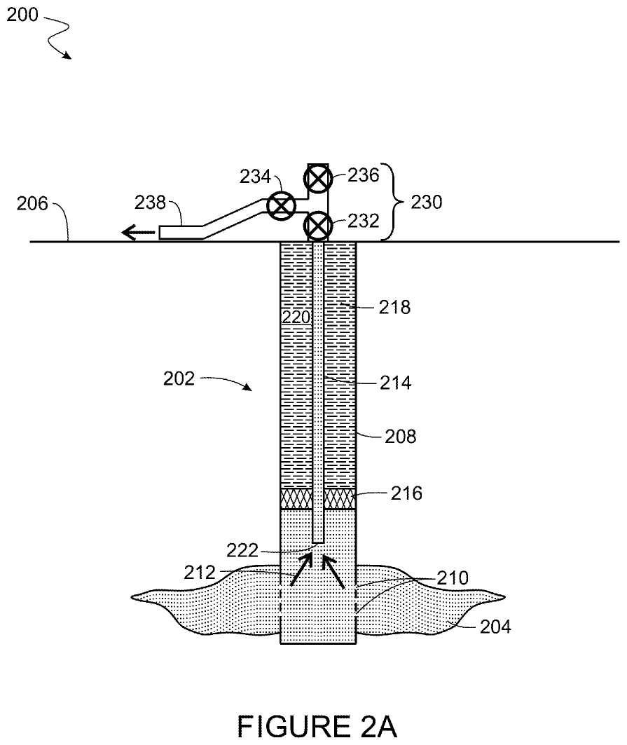

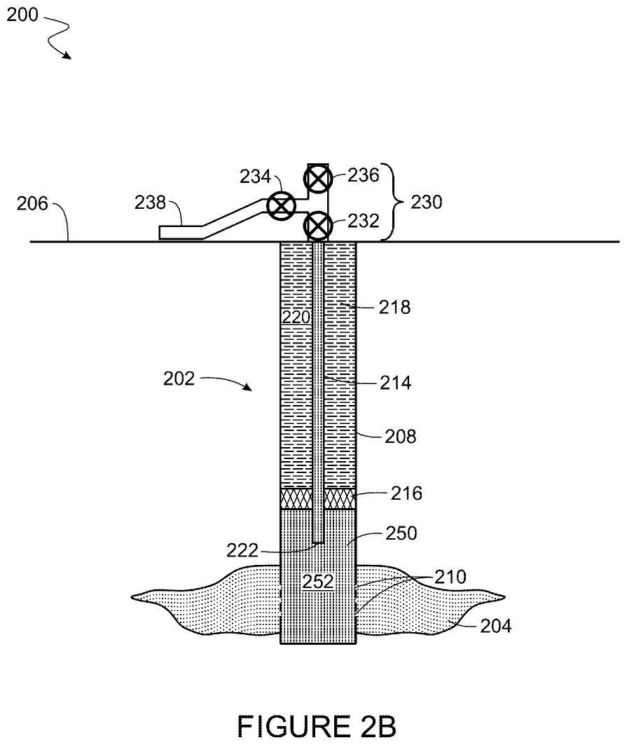

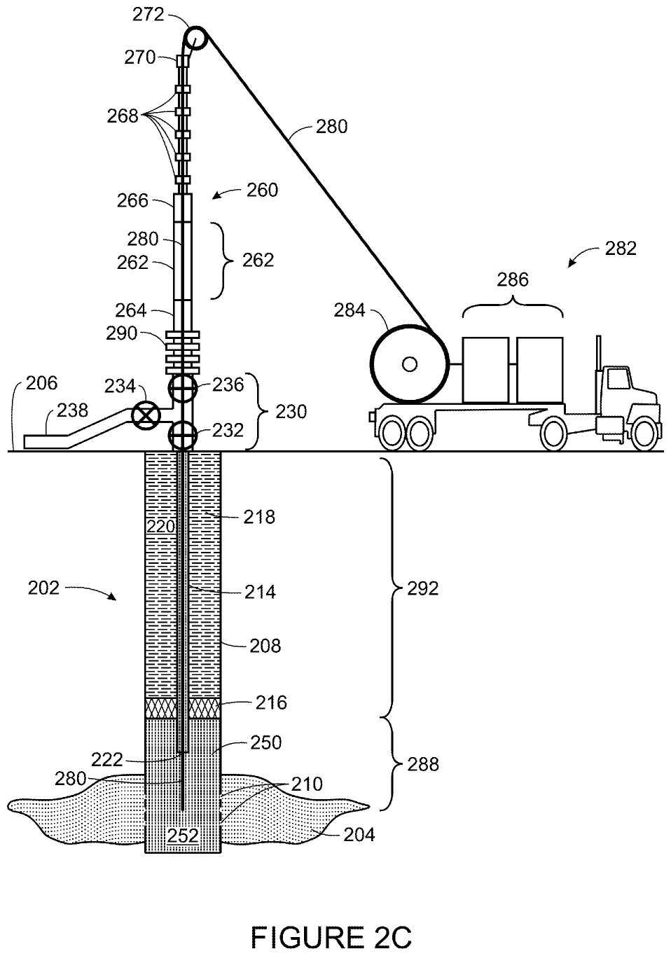

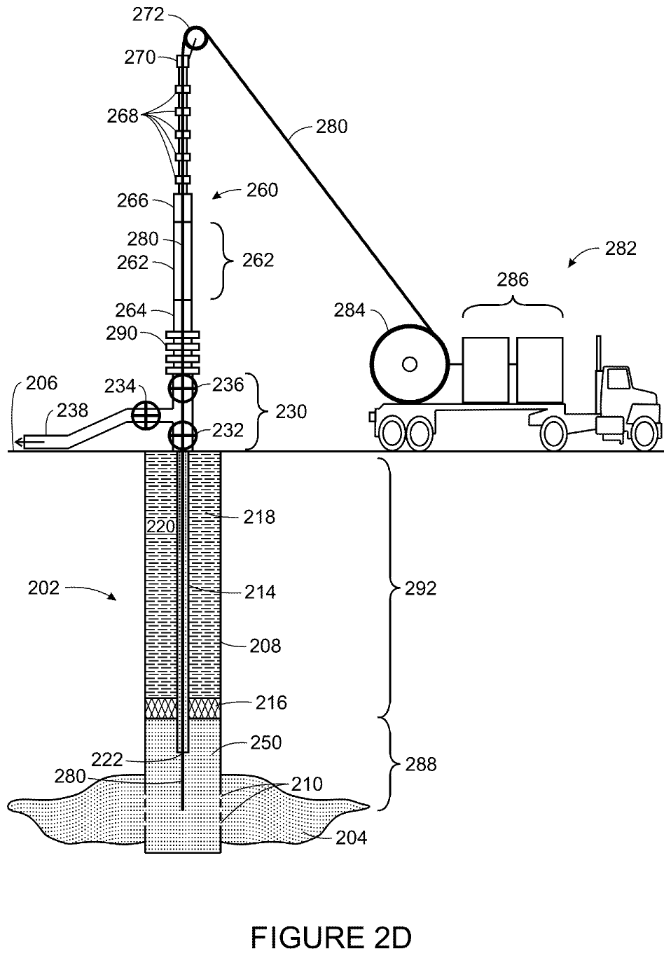

FIG. 1 is a process flow diagram of a method 100 of well operations including normal flow of produced fluids, a well kill operation, and reversing of the well kill, in accordance with an embodiment of the present disclosure. Method 100 is described in reference to a well system of an embodiment of the present disclosure shown in the schematic illustrations of FIGS. 2A-2D. Method 100 begins with step 102, in which well system 200 of FIG. 2A is in its operational state. Well system 200 includes a wellbore 202 drilled into a subterranean zone 204 from a surface location 206. Casing string 208 is disposed within wellbore 202 and can include multiple nested casings of different diameters. Perforations 210 in casing string 208 permit a flow of produced fluid 212 such as oil, gas, water, or other fluid from subterranean zone 204 into wellbore 202. Wellbore 202 may be a substantially vertical well, a substantially non-vertical (for example, horizontal) well, or may be substantially vertical along one or more portions of its length and substantially non-vertical along other portions of its length.

Production tubing string 214 is positioned within casing string 208 and provides a passageway through which produced fluid 212 produced from subterranean zone 204 can reach the surface location 206. The inner surface of casing string 208 and the outer surface of production tubing string 214 define (or partially define) the tubing-casing annulus (TCA) 218. A production packer 216 anchors and isolates the open downhole end 222 of the production tubing string 208 from the uphole portion of TCA 218. Packer fluid 220 fills or substantially fills TCA 218 uphole of packer 216 and can include or can be a mixture of diesel, brine, or other suitable fluid.

Well system 200 further includes a wellhead assembly 230 at the surface location 206 (more specifically, at the uphole end of wellbore 202), which can include hangers for casing string 208 and production tubing string 214 and can include various valves, spools, pressure gauges, chokes, and other wellhead assembly components to regulate and control production of produced fluid 212 from wellbore 202. Such components can include master valve 232 at a lower end of assembly 230 and configured to regulate flow of fluids emerging from wellbore 202 into the upper components of assembly 230. With master valve 232 open, produced fluids 212 can be flowed from wellbore 202 into the central bore of the wellhead assembly. With wing valve 234 open, produced fluids can then flow via flowline 238 to pipelines and/or to other surface treatment, gathering, or conveyance facilities, as shown in FIG. 1. At the top-most portion of the wellhead, crown valve 236 provides vertical access to the central bore of wellhead assembly 230 and, with master valve 232 open, into wellbore 202 when necessary for service, repair, and other well operations.

Method 100 proceeds to step 104, in which the operator determines if a well kill operation is necessary or desired (i.e., as described above, to temporarily or permanently control or stop fluid flowing from subterranean zone 204 into production tubing string 214). If at step 104 the operator determines that a well kill is not necessary or desirable the method returns to step 102 and production continues. If however the operator determines at step 104 that a well kill is necessary or desired, then the method proceeds to step 106 in which well kill operations are initiated by first closing wing valve 234. Proceeding to step 108, a kill fluid 250 from the surface is disposed through production tubing string 214 and out its downhole end 222, using conventional methods. Kill fluid 250 can comprise a heavy brine or other fluid having a density relative to the produced fluid at the ambient temperature of the downhole environment at downhole end 222 such that, when a sufficient volume 252 of the kill fluid 250 is disposed at the downhole end 222, it prevents the flow of produced fluid into the production tubing string 214. In some embodiments kill fluid 250 can include barite, hematite, and/or other additives to increase the density and thus effectiveness of the fluid in killing the well without damaging the perforations or subterranean zone materials, or other suitable additives. In some embodiments, a kill fluid can have a density of approximately 1100 kg/m³. In other embodiments the kill fluid may have a greater or lesser density. At step 110, the remaining wellhead assembly valves can be closed. In some embodiments, the wellhead assembly can then be temporarily or permanently removed from the wellhead.

As described above, after a well has been killed, it may be necessary or desirable to “reverse” the well kill; i.e., to bring the well back from the killed state shown in FIG. 2B to the producing state shown in FIG. 2A. Method 100 proceeds to step 112, in which the operator determines if it is necessary or desired to reverse the well kill operation. If at step 112 the operator determines that a well kill reversal is not necessary or desirable then at step 114 the wellhead assembly valves remain closed at step 114 until a different reversal decision is made.

If at step 112 the operator determines that a well kill reversal is necessary or desired, then a well kill reversal is conducted, as shown in FIG. 2C. The kill reversal can be initiated at step 116 by installing a lubricator assembly 260 on wellhead assembly 230, as shown in FIG. 2C. In the illustrated embodiment, lubricator assembly 260 sits atop a blowout preventer 290, and can include, in addition to a lubricator/riser 262, conventional lubricator assembly components such as a tool trap 264, tool catcher 266, grease injector ports 268, stuffing box 270, and sheave 272. These components enable insertion of cables or other intervention tools into the production tubing string while maintaining pressure control of the system.

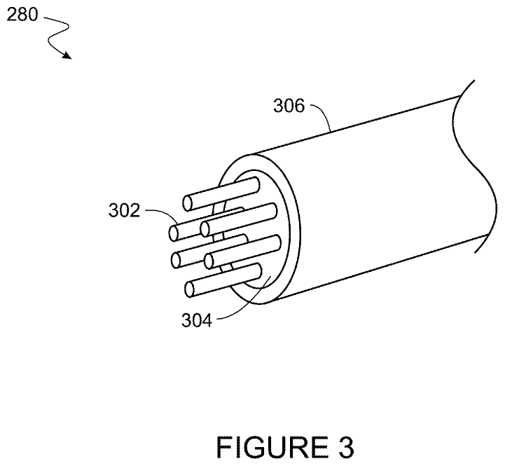

Proceeding to step 118, heater cable 280 is inserted into lubricator assembly 260. Heater cable 280 include conductive wires with sufficient electrical resistance so as to generate heat energy as electrical current flowed through the wires. Heater cable 280 can be, for example, a mineral insulated (MI) cable as shown in FIG. 3, comprising conductor wires 302 within a magnesium oxide core 304, encapsulated by a metal sheath 306. Such heater cables can be obtained from various suppliers, including but not limited to Omega Engineering of Norwalk, Connecticut.

Although magnesium oxide has proven to be an effective insulator for downhole cables, some alternatives may also be considered. For example, calcium magnesium silicate (CMS) can be suitable, given its high dielectric strength, thermal endurance, and moisture resistance. Aluminum oxide ceramic also has desirable properties in terms of dielectric strength and thermal conductivity. Other embodiments may utilize cable comprised of mica paper or high-temperature polymers such as PTFE. These benefits such as flexibility and chemical resistance. The choice of insulator depends on factors, which include maximum temperature rating required, moisture levels anticipated, mechanical stresses, and material cost.

Fiber optic cables may be integrated into the system to allow for distributed sensing capabilities, for example. acoustic, temperature, etc. The fiber optic line may be incorporated into the heating cable sub-assembly to provide real-time monitoring of the ambient conditions of operation of the heating cable. The data received at surface from downhole distributed sensing line may be used to optimize heating power delivery during operation. Fundamental application of the heating cable is discussed below.

A heater cable 280 can be conveyed from a drum reel 284 of a surface power and control system 282. Surface power and control system 282 can include skid-mounted equipment 286 comprised of diesel/petrol generator, power transformers, and other suitable equipment to selectively flow electrical current through heater cable 280, and to step-up or adjust the voltage as desired by the operator.

At step 120, with heater cable 280 within lubricator 262, crown valve 236 and master valve 232 are opened while wing valve 234 remains closed. At step 122, heater cable 280 is inserted through the open crown valve 236 and master valve 232 into the production tubing string 214, and the cable lowered by unwinding reel 284 so as to be at least partially immersed into the volume 252 of kill fluid 250 as designated in step 124. In the illustrated embodiment, heater cable 280, when so inserted, extends downhole from downhole end 222 of production tubing string 214, into the volume 252. Thus, because insertion of heater cable 280 requires only conventional intervention tools and heater cable 280 hangs loose within production tubing string 214 (i.e., the cable is not clamped to the exterior or interior of the tubing string or to other downhole components), removal of tubing string 214 or other complicated manipulations of downhole components are not required.

At step 126, wing valve 234 is opened and, at step 128, electrical current is flowed through heater cable 280 from surface power and control system 282. The electricity supplied to the heater cable is converted to heat energy which is transferred via conduction to the kill fluid, raising the temperature of the kill fluid and thereby reducing the density of the well kill fluid relative to the produced fluids. This results in a lower hydrostatic pressure of the kill fluid column. As the fluid temperature continues to increase with further resulting decrease in fluid density, a point is reached when the density reaches a value such that the kill-fluid hydrostatic pressure force is not sufficient to provide the overbalance pressure-force. The net higher pressure-force by the reservoir fluid causes the kill fluid to rise within the production tubing string. In some embodiments, a temperature increase of approximately 70° C. and/or a decrease in density of approximately 5% may be sufficient to initiate the desired fluid movement.

At step 130, as the kill fluid rises within the production tubing string and through wellhead assembly 230, it flows out of the flowline 238, and is displaced within the production tubing by produced fluids from the production zone. When the displacement is complete, then, at step 132, the electrical current can be shut off. At step 134, the heater cable 280 is removed from the production tubing string. In the illustrated embodiment, heater cable 280, when deployed so as to be immersed in the kill fluid volume, is loosely hung within the production tubing string 214. By “loosely hung” it is meant that, below the wellhead, the cable is not attached to the interior or exterior of the tubing string with clamps or other attaching devices. Thus, removal of the heater cable 280 is easily accomplished by merely winding the cable back to drum reel 284. At step 136, the crown valve 236 can be closed and the lubricator assembly removed from the wellhead assembly as produced fluid, having fully displaced the kill fluid, begins to flow through the flowline 238, thus completing the return of the well system to the operational state of step 102.

In the illustrated embodiment, heater cable 280 includes a downhole section 288 and an uphole section 292. In some embodiments, the composition and/or construction of the heater cable 280 in downhole section 288 may differ from the composition and/or construction of uphole section 292, so as to have different heating characteristics. For example, downhole section 288 can be constructed and configured such that it is a “main heating section,” i.e., the magnitude of heating power per unit length of cable along section 288 is greater than the magnitude of heating power per unit length of cable along section 292. In some embodiments, the system is configured such that a portion or all of section 288 extends below the downhole end 222 of production tubing string 214 and is fully or partially immersed in volume 252. In other embodiments, the system can be configured such that all or a portion of section 288 does not extend below downhole end 222. In other embodiments, the magnitude of heating power per unit length of cable along section 288 is less than (rather than greater than) the magnitude of heating power per unit length of cable along section 292.

In some embodiments, the heater cable system and method of the present disclosure can be used as an adjunct to a lift system such as an electric submersible pump (ESP). In some embodiments, an electrical power cable to the ESP can be run along the off-set leg of a Y-tool. The heater cable can be run in the other (through) leg of the Y-tool so as to extend downhole past the ESP, such that the heater cable can be immersed in the kill fluid below the ESP, thus enabling heat to be applied to the kill fluid below the ESP to lighten the well fluid. Such a reduction in density of the kill fluid can enable effective ESP operation in circumstances in which the ESP would otherwise lack sufficient power to lift a high-density kill fluid, and/or can enable kill fluid removal in the event of an ESP failure.

In some embodiments, fiber optic cables may be incorporated as a component of the heater cable, thus enabling real-time, distributed sensing capabilities, for example, measurements of acoustics, temperature, and other parameters of the ambient conditions of operation of the heating cable. The data received at surface from downhole distributed sensing line may be used to optimize heating power delivery during operation.

The term “uphole” as used herein means in the direction along a wellbore from its distal end towards the surface and through the wellhead, and “downhole” as used herein means the direction through the wellhead and along the wellbore from the surface towards the wellbore's distal end. A downhole location means a location along a wellbore downhole of the surface.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate. Accordingly, the previously described example implementations do not define or constrain the present disclosure. Other changes, substitutions, and alterations are also possible without departing from the spirit and scope of the present disclosure.

### EXAMPLES

In a first aspect, a method includes disposing a heater cable through a wellhead assembly into a production tubing string, the production tubing string positioned within a wellbore drilled into a subterranean zone and configured to convey a flow of produced fluids from the subterranean zone to the wellhead assembly. The heater cable is lowered within the production tubing string in a downhole direction such that the heater cable is at least partially immersed within a volume of a well kill fluid disposed at a downhole end of the production tubing string. Prior to the immersion, a density of the well kill fluid relative to the produced fluids at the downhole end is such that the volume of well kill fluid prevents the flow of the produced fluids from the subterranean zone into the production tubing string. An electric current is flowed though the heater cable, and the heater cable converts the electric current to heat energy. The heat energy is transferred by conduction to the kill fluid thereby reducing the density of the well kill fluid relative to the produced fluids such that the well kill fluid rises in an uphole direction through the production tubing string.

In a second aspect in accordance with the first aspect, lowering the heater cable within the production tubing string includes lowering the heater cable such that a portion of the heater cable extends below a downhole end of the production tubing string.

In a third aspect in accordance with the first or second aspects, a magnitude of heating power per unit length of a first section of cable is less than the magnitude of heating power per unit length of a second section of cable.

In a fourth aspect in accordance with the third aspect, when the heater cable is immersed in the volume of well kill fluid, the second section of cable is downhole of the first section.

In a fifth aspect in accordance with the fourth aspect, when the heater cable is immersed in the volume of well kill fluid, at least a portion of the second section extends below a downhole end of the production tubing string and is disposed in the volume of well kill fluid.

In a sixth aspect in accordance with any of the first to fifth aspects, the heater cable, when immersed in the volume of well kill fluid, is loosely hung within the production tubing string.

In a seventh aspect in accordance with any of the first to sixth aspects, the heater cable, when immersed in the volume of well kill fluid, is not clamped to an interior or interior surface of the production tubing string.

In an eighth aspect in accordance with any of the first to seventh aspects, disposing the heater cable through the wellhead assembly into a production tubing string includes inserting the heater cable through a crown valve via a lubricator assembly.

In a ninth aspect in accordance with any of the first to eighth aspects, the method further includes removing the heater cable from the production tubing string via the lubricator assembly and thereafter resuming production from the well.

In a tenth aspect in accordance with any of the first to ninth aspects, the heater cable includes an optical fiber.

In an eleventh aspect, a system that includes a production tubing string positioned within a well and configured to carry produced fluids from a subterranean zone to a terranean surface location and a wellhead assembly at the surface location configured to regulate a flow of fluid from the production tubing string. A volume of well kill fluid is disposed in the production tubing, with the well kill fluid having a density relative to the produced fluids at an ambient downhole temperature such that the volume of well kill fluid at the ambient downhole temperature prevents the flow of the produced fluids from the subterranean zone into the production tubing string. The system further includes a heater cable disposed through the wellhead assembly and into the volume of well kill fluid. The heater cable is configured such that, when an electric current is flowed through the heater cable, the electrical current is converted to heat energy and the heat energy is transferred by conduction to the kill fluid, thereby reducing the density of the well kill fluid relative to the produced fluids such that the well kill fluid rises in an uphole direction through the production tubing string, thereby permitting a flow of the produced fluids from the subterranean zone into the production tubing string.

In a twelfth aspect in accordance with the eleventh aspect, a portion of the heater cable extends below a downhole end of the production tubing string.

In a thirteenth aspect in accordance with the eleventh or twelfth aspects, a magnitude of heating power per unit length of a first section of cable is less than the magnitude of heating power per unit length of a second section of cable.

In a fourteenth aspect in accordance with the thirteenth aspect, the second section of cable is downhole of the first section.

In a fifteenth aspect in accordance with the fourteenth aspect, at least a portion of the second section extends below a downhole end of the production tubing string and is disposed in the volume of well kill fluid.

In a sixteenth aspect in accordance with any of the eleventh to fifteenth aspects, the heater cable is loosely hung within the production tubing string.

In a seventeenth aspect in accordance with any of the eleventh to sixteenth aspects, the heater cable is not clamped to an interior or interior surface of the production tubing string

In an eighteenth aspect in accordance with any of the eleventh to seventeenth aspects, the heater cable is disposed into the wellhead assembly through a crown valve.

In a nineteenth aspect in accordance with any of the eleventh to eighteenth aspects, the heater cable includes an optical fiber.

In a twentieth aspect in accordance with any of the eleventh to nineteenth aspects, the system further includes an electric submersible pump disposed in the wellbore uphole of a section of the heater cable disposed in the volume of well kill fluid.

1. A method comprising:
disposing, through a wellhead assembly into a production tubing string, a heater cable configured to generate heat energy from resistance of the heater cable to an electrical current, the production tubing string positioned within a wellbore drilled into a subterranean zone, wherein a volume of well kill fluid is disposed in the production tubing string and below a downhole end of the production tubing string and wherein a density of the well kill fluid relative to produced fluids from the subterranean zone at ambient downhole temperature is such that the volume of well kill fluid prevents the flow of the produced fluids into the production tubing string;
lowering a heater cable within the production tubing string in a downhole direction such that a first section of the heater cable is immersed within the volume of well kill fluid in the production tubing string and at least a portion of a second section of the heater cable extends downhole of the first section into the volume of well kill fluid below the downhole end of the production tubing string;
flowing the electric current though the heater cable, the heater cable converting the electric current to heat energy in the first section and the second section, the heat energy transferred by conduction to the volumes of well kill fluid in the production tubing string and below the downhole end of the production tubing string and thereby reducing the density of the well kill fluid in the production tubing string and below the downhole end of the production tubing string relative to the produced fluids such that the well kill fluid rises in an uphole direction through the production tubing string.

2. (canceled)

3. The method of claim 1, wherein a magnitude of heating power per unit length of the first section of cable is than less than the magnitude of heating power per unit length of the second section of cable.

4. (canceled)

5. (canceled)

6. The method of claim 1, wherein the heater cable, when immersed in the volume of well kill fluid, is loosely hung within the production tubing string.

7. The method of claim 1, wherein the heater cable, when immersed in the volume of well kill fluid, is not clamped to an exterior or interior surface of the production tubing string.

8. The method of claim 1, wherein disposing the heater cable through the wellhead assembly into a production tubing string comprises inserting the heater cable through a crown valve via a lubricator assembly.

9. The method of claim 8, further comprising removing the heater cable from the production tubing string via the lubricator assembly and thereafter resuming production from the well.

10. The method of claim 1, wherein the heater cable comprises an optical fiber.

11. A well system comprising:
a production tubing string positioned within a well and configured to carry produced fluids from a subterranean zone to a terranean surface location;
a wellhead assembly at the surface location configured to regulate a flow of fluid from the production tubing string;
a volume of well kill fluid disposed in the production tubing string and below a downhole end of the production tubing string, the well kill fluid having a density relative to the produced fluids at an ambient downhole temperature such that the volume of well kill fluid at the ambient downhole temperature prevents the flow of the produced fluids from the subterranean zone into the production tubing string;
a heater cable disposed through the wellhead assembly, the heater cable configured to generate heat energy from resistance of the heater cable to an electrical current, a first section of the heater cable immersed within the volume of well kill fluid in the production tubing string and at least a portion of a second section of the heater cable extending downhole of the first section into the volume of well kill fluid below the downhole end of the production tubing string into the volume of well kill fluid below the downhole end of the production tubing string, the heater cable configured to generate heat energy from resistance of the heater cable to electrical current such that, when an electric current is flowed through the heater cable, heat energy is transferred by conduction to the volumes of kill fluid in the production tubing string and below the downhole end of the production tubing string, thereby reducing the density of the well kill fluid in the production tubing string and below the downhole end of the production tubing string relative to the produced fluids such that the well kill fluid rises in an uphole direction through the production tubing string, thereby permitting a flow of the produced fluids from the subterranean zone into the production tubing string.

12. (canceled)

13. The system of claim 11, wherein a magnitude of heating power per unit length of the first section of cable is than less than the magnitude of heating power per unit length of the second section of cable.

14. (canceled)

15. (canceled)

16. The system of claim 11, wherein the heater cable is loosely hung within the production tubing string.

17. The system of claim 11, wherein the heater cable is not clamped to an exterior or interior surface of the production tubing string.

18. The system of claim 11, wherein the heater cable is disposed into the wellhead assembly through a crown valve.

19. The system of claim 11, wherein the heater cable comprises an optical fiber.

20. The system of claim 11, further comprising an electric submersible pump disposed in the wellbore uphole of a section of the heater cable disposed in the volume of well kill fluid.
